(19) United States
(12) Patent Application Publication
(10) Pub. No.: US 2003/0063195 A1
(43) Pub. Date: Apr. 3, 2003

(54) Automatic focusing device

(75) Inventors: Noriyuki Okisu, Osakasayama-Shi (JP); Keiji Tamai, Suita-Shi (JP); Masahiro Kitamura, Osaka-Shi (JP); Motohiro Nakanishi, Kobe-Shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd.

(21) Appl. No.: 10/256,509

(22) Filed: Sep. 27, 2002

(30) Foreign Application Priority Data
Oct. 1, 2001 (JP) 2001-305061

(51) Int. Cl. H04N 5/232

(52) U.S. Cl. 348/208.16; 348/345; 348/350

(57) ABSTRACT

An automatic focusing device capable of preventing the subject to be brought into focus from falling outside the AF block due to a light image shift, comprising: an automatic focusing controller for calculating an optical physical quantity within an automatic focusing block as which an area in image data is specified, and determining the degree of focus of the image data; and a light image shift occurrence determiner for predicting or detecting the occurrence of a light image shift, wherein the automatic focusing controller changes the size of the automatic focusing block when the light image shift occurrence determiner predicts or detects the occurrence of a light image shift.

This application is based on Japanese Patent Application No. Hei 2001-305061 filed in Japan on Oct. 1, 2001, the entire content of which is hereby incorporated by reference.

### FIELD OF THE INVENTION

The present invention relates to an automatic focusing device used being incorporated in an apparatus such as a digital camera or a video camera.

### DESCRIPTION OF RELATED ART

Generally, in automatic focusing devices, an optical physical quantity is calculated within an automatic focusing block (hereinafter, referred to as AF block) as which an area (generally, an area in the center of the image plane) in image data is specified, and with the calculated quantity as an automatic focusing evaluation value (hereinafter, referred to as AF evaluation value), the lens moved out position of a digital camera or a video camera is set to the position of in-focus state.

Specifically, a contrast AF method is frequently adopted in which contrast which is one optical physical quantity in the AF block at each lens moved out position is calculated while the lens moved out position is moved back and forth and the contrast is as the AF evaluation value. The lens moved out position where the contrast is highest is regarded as the position of in-focus state and the lens moved out position is readjusted to the position of in-focus state, whereby an automatic focusing function is realized. Examples of the contrast calculation method include a method in which the differences in brightness between the adjoining pixels are obtained and the differences are integrated in the entire AF block.

By setting a small AF area in the image data at this time, in-focus state can be precisely obtained for a smaller area in the image data.

FIG. 13 is a view showing an example of an image obtained in a case where a subject 2 (in this example, a person) falls in an AF block 1 and photographing is performed with the subject 2 being in focus.

The variation in the AF evaluation value with respect to the lens moved out position at this time is shown by the graph 31 of FIG. 15. In the graph 31, the point P representative of the peak is determined to be the lens moved out position of in-focus state.

However, there can be cases where the point P of the graph 31 is not regarded as the position of in-focus state because of a light image shift caused by a shake of the user's hands holding a digital camera or a video camera. FIG. 14 is a view showing an example of an image obtained in such a case. In FIG. 14, the subject 2 is outside the AF block 1.

When the subject 2 falls outside the AF block 1 due to a light image shift as described above, it affects the relationship between the AF evaluation value and the lens moved out position as well. That is, in FIG. 15, the variation in the AF evaluation value with respect to the lens moved out position is not like the graph 31 but like the graph 32. In the graph 32, the AF evaluation value decreases in the area on the right of the point Q, and the position of the peak of the AF evaluation value is not the point P but shifted to the point Q. Consequently, it is erroneously determined that the lens moved out position of in-focus state is not the point P but the point Q, so that the subject 2 is out of focus.

### SUMMARY OF THE INVENTION

The present invention is made to solve the above-described problem, and an object thereof is to provide an automatic focusing device capable of preventing the subject to be brought into focus from falling outside the AF block due to a light image shift.

The above-mentioned object is attained by providing an automatic focusing device having the construction described below.

An automatic focusing device of the present invention is provided with: automatic focusing controller for calculating an optical physical quantity within an automatic focusing block as which an area in image data is specified, and determining the degree of focus of the image data; and light image shift occurrence determiner for predicting or detecting the occurrence of a light image shift. The automatic focusing controller changes the size of the automatic focusing block when the light image shift occurrence determiner predicts or detects the occurrence of a light image shift.

In the above-described construction, the automatic focusing controller captures the image data at predetermined time intervals and determines the degree of focus of the image data, and the light image shift occurrence determiner predicts the occurrence of a light image shift based on information on the focal length of an imaging lens and/or information on the predetermined time interval.

In the above-described construction, the light image shift occurrence determiner predicts the occurrence of a light image shift when the focal length is not less than a first predetermined value and/or predicts the occurrence of a light image shift when the predetermined time interval is not less than a second predetermined value.

In the above-described construction, the light image shift occurrence determiner detects a light image shift by detecting the value of a velocity element or an acceleration element of an apparatus performing focus control with the automatic focusing device.

In the above-described construction, the size of the automatic focusing block after the change is larger than that before the change.

In the above-described construction, the light image shift occurrence determiner detects, or identifies by a prediction based on the image data change, the light image shift amount and/or the light image shift direction, and the automatic focusing controller changes the size of the automatic focusing block according to the light image shift amount and/or the light image shift direction.

In the above-described construction, the automatic focusing controller performs at least one of a first processing to change the size of the automatic focusing block so that the larger the light image shift amount is, the larger than the size before the change the size of the automatic focusing block is and a second processing to place the automatic focusing block so as to extend in the same direction as the light image shift direction.

In the above-described construction, warning portion is further provided for outputting a warning that the light image shift amount is too large when the light image shift amount is larger than a third predetermined value.

In the above-described construction, the automatic focusing controller corrects the position of the automatic focusing block based on the information on the light image shift amount and/or the light image shift direction.

Moreover, an automatic focusing device of the present invention is provided with: automatic focusing portion for performing focusing of image data by using image information in the image data; light image shift detecting portion for detecting information on a light image shift; and changing portion for changing a method for obtaining the image information by the automatic focusing portion, based on an output from the light image shift detecting portion.

In the above-described construction, the automatic focusing portion calculates an optical physical quantity within an automatic focusing block as which an area in the image data is specified, and determines the degree of focus of the image data.

In the above-described construction, the change of the obtaining method by the changing portion is made by changing the size of the automatic focusing block.

In the above-described construction, the changing portion changes the size of the automatic focusing block so that it is larger than that before the change, when the light image shift detecting portion detects the occurrence of a light image shift.

Moreover, an automatic focusing device of the present invention is provided with: automatic focusing portion for performing focusing of image data by using image information in the image data; and light image shift occurrence determining portion for predicting or detecting the occurrence of a light image shift. The automatic focusing portion is provided with changing portion for changing a method for obtaining the image information by the automatic focusing portion, when the light image shift occurrence determining portion predicts or detects the occurrence of a light image shift.

In the above-described construction, the automatic focusing portion calculates an optical physical quantity within an automatic focusing block as which an area in the image data is specified, and determines the degree of focus of the image data.

In the above-described construction, the change of the obtaining method by the changing portion is made by changing the size of the automatic focusing block.

In the above-described construction, the changing portion changes the size of the automatic focusing block so that it is larger than that before the change, when the light image shift detecting portion detects the occurrence of a light image shift.

In the above-described construction, the light image shift occurrence determining portion detects, or identifies by a prediction based on the image data change, the light image shift amount and/or the light image shift direction, and the automatic focusing portion changes the size of the automatic focusing block according to the light image shift amount and/or the light image shift direction.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a view showing the size of the AF block after a change when the occurrence of a light image shift is predicted;

FIG. 2 is a view of assistance in explaining that the subject does not readily fall outside the changed AF block;

FIG. 3 is a block diagram showing the structure of a digital camera including an automatic focusing device according to a first embodiment of the present invention;

FIG. 4 is a block diagram showing functions of a general controller 270 of the digital camera of FIG. 3;

FIG. 5 is a flowchart showing processing of the automatic focusing device according to the first embodiment of the present invention;

FIG. 6 is a block diagram showing the structure of a digital camera including an automatic focusing device according to a second embodiment and a third embodiment of the present invention;

FIG. 7 is a block diagram showing functions of the general controller 270 of the digital camera of FIG. 6;

FIG. 8 is a flowchart showing processing of the automatic focusing device according to the second embodiment of the present invention;

FIG. 9 is a view showing another example of the placement of the AF block after the change when the occurrence of a light image shift is detected;

FIG. 10 is a view showing another example of the placement of the AF block after the change when the occurrence of a light image shift is detected;

FIG. 11 is a view showing another example of the placement of the AF block after the change when the occurrence of a light image shift is detected;

FIG. 12 is a flowchart showing processing of the automatic focusing device according to the third embodiment of the present invention;

FIG. 13 is a view showing the example of the image obtained in the case where the subject falls in the AF block and photographing is performed with the subject being in focus

FIG. 14 is a view showing the example of the image obtained in the case where the subject is out of focus because of a light image shift caused by a shake of the user's hands holding a digital camera or a video camera; and

FIG. 15 is a view showing the variation in the AF evaluation value with respect to the lens moved out position.

### DETAILED DESCRIPTION OF THE PREFERRED EMBODIMENTS

<First Embodiment>

The present embodiment is an automatic focusing device structured so that when the occurrence of a light image shift is predicted, the size of the AF block is changed so that the subject does not readily fall outside the AF block. With this, an automatic focusing device can be realized that is capable of preventing the subject to be brought into focus from falling outside the AF block.

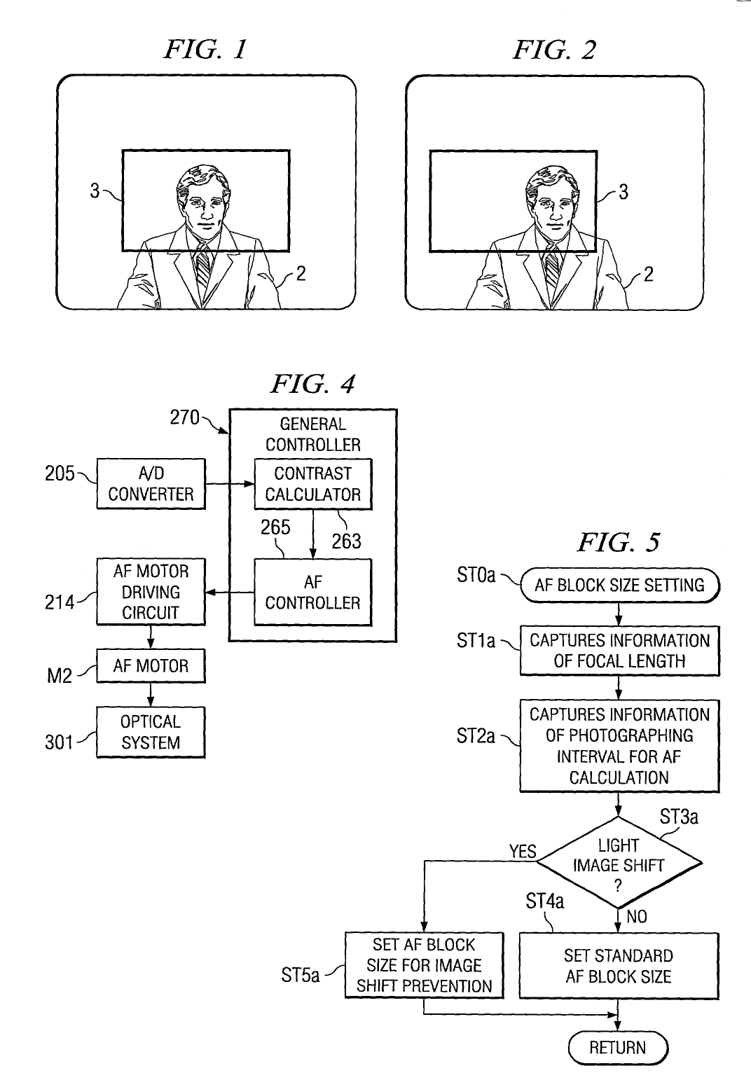

Specifically, a square AF block 1 as shown in FIGS. 13 and 14 is changed to a larger square AF block 3 as shown in FIG. 1.

By doing this, even if the user causes a light image shift in photographing a subject, the subject 2 does not readily fall outside the AF block 3 as shown in FIG. 2. In this case, the relationship between the AF evaluation value and the lens moved out position remains that of the graph 31 in FIG. 15, and the position of the peak of the AF evaluation value does not readily shift from the point P.

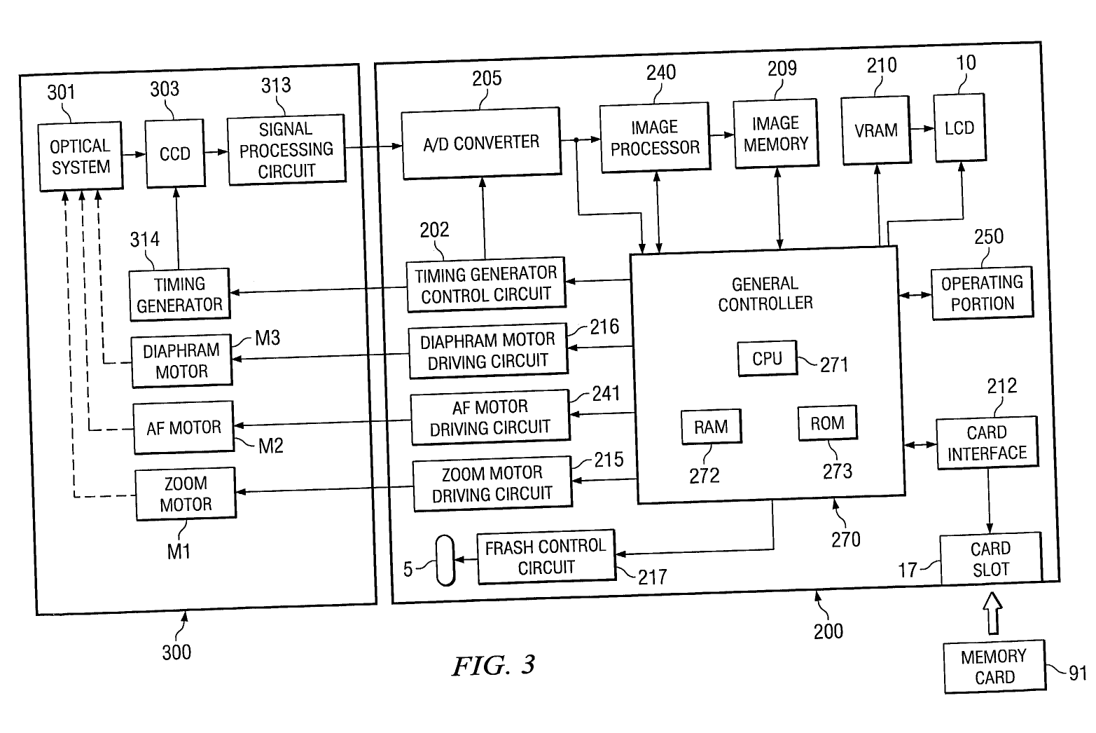

FIG. 3 is a block diagram showing the structure of a digital camera as an example of the apparatus including the automatic focusing device according to the present embodiment. As shown in FIG. 3, the digital camera comprises a camera body section 200 and an imaging section 300.

In the imaging section 300, a zoom motor M1, an automatic focusing motor M2 and a diaphragm motor M3 are driven by a zoom motor driving circuit 215, a focusing motor driving circuit 214 and a diaphragm motor driving circuit 216 provided in the camera body section 200, respectively. The driving circuits 214 to 216 drive the motors M1 to M3 based on a control signal supplied from a general controller 270 of the camera body section 200.

A charge-coupled device (CCD) 303 of the imaging section 300 photoelectrically converts the light image of the subject formed by a optical system 301 into image signals (signals comprising a string of pixel signals received at the pixels) of color components of R (red), G (green) and B (blue), and outputs the image signals.

A timing generator 314 generates a driving control signal for the CCD 303 based on a reference block transmitted from a timing control circuit 202 of the camera body section 200. The timing generator 314 generates clock signals such as a timing signal for starting and ending integration (starting and ending exposure) and signals for controlling reading of light reception signals of the pixels (for example, a horizontal synchronizing signal, a vertical synchronizing signal and a transfer signal), and outputs the generated signals to the CCD 303.

A signal processing circuit 313 performs predetermined analog signal processing on the image signals (analog signals) output from the CCD 303. The signal processing circuit 313 has a correlation double sampling (CDS) circuit and an automatic gain control (AGC) circuit, and reduces the noise of the image signals with the CDS circuit and adjusts the gain with the AGC circuit to thereby adjust the levels of the image signals.

Next, blocks of the camera body section 200 will be described.

In the camera body section 200, an analog-to-digital (A/D) converter 205 converts (A/D converts) the signal of each pixel of the image into a digital signal of, for example, 12 bits. The A/D converter 205 converts the pixel signals (analog signals) into digital signals based on a reference block for A/D conversion input from the timing control circuit 202.

The timing control circuit 202 is structured so as to generate the reference clocks for the timing generator 314 and the A/D converter 205. The timing control circuit 202 is controlled by the general controller 270.

The digital signals converted by the A/D converter 205 are input to an image processor 240 and the general controller 270. The digital signal input to the image processor 240 undergoes various kinds of image processing at the image processor 240, and is then stored into a memory card 91 as a shot image or used as a live view display image. The digital signal input to the general controller 270 is used for the general controller 270 to calculate the brightness of the incident light from the subject, the color balance, the contrast and the like.

An image memory 209 is a memory for storing the data of the images output from the image processor 240. The image memory 209 has at least a storage capacity corresponding to one frame. That is, when the CCD 303 has n by m pixels, the image memory 209 has a storage capacity corresponding to data of n by m pixels, and the data of each pixel is stored at the corresponding address.

A video random-access memory (VRAM) 210 is a buffer memory for images played back on a liquid crystal display (LCD) 10. The VRAM 210 has a storage capacity with which image data corresponding to the number of pixels of the LCD 10 can be stored.

A flash control circuit 217 for controlling light emission of a built-in flash 5 causes the built-in flash 5 to emit light for a predetermined period of time based on a light emission start signal from the general controller 270.

A card interface 212 is for writing and reading images to and from the memory card 91 through a card slot 17.

An operation portion 250 includes various switches and buttons. The information input by the user is transmitted to the general controller 270 through the operation portion 250.

The general controller 270 comprising a microcomputer centralizedly controls the photographing function and the playback function. The general controller 270 has: a central processing unit (CPU) 271 being the main unit thereof; a read-only memory (ROM) 273 storing a program for organically controlling the driving of each member in the imaging section 300 and the camera body section 200; and a RAM 272 serving as the work area for calculations. Programs recorded on storage media such as the memory card 91 can be read out through the card interface 212 and stored in the ROM 273.

FIG. 4 is a block diagram showing functions of the general controller 270. In FIG. 4, a contrast calculator 263 and an automatic focusing (AF) controller 265 are function blocks representative of functions realized by the program stored in the ROM 273 of the general controller 270. The contrast calculator 263 and the AF controller 265 jointly realize the function of the automatic focusing device of the present embodiment.

The contrast AF method is also adopted in the automatic focusing control of the present embodiment. That is, the contrast calculator 263 evaluates the contrast of the signal from the A/D converter 205, and the AF controller 265 supplies a signal to the focusing motor driving circuit 214 so that the contrast increases, and drives the position of a focusing lens 311 through the AF motor M2.

In the present embodiment, as described above, the AF block is changed to a larger one when the occurrence of a light image shift is predicted.

The AF block is generated by the AF controller 265. The superimposition of the AF block image on the imaging screen is performed by the image processor 240, whereas the calculation of the contrast in the AF block is performed by the contrast calculator 263.

Therefore, the AF controller 265 predicts the occurrence of a light image shift, and changes the AF block from the small square AF block 1 as shown in FIGS. 13 and 14 to the larger square AF block 3 as shown in FIG. 1. The prediction of the occurrence of a light image shift and the change of the size of the AF block can be easily performed only by changing the program of the general controller 270.

Now, a method of predicting the occurrence of a light image shift will be described.

The longer the focal length of the imaging lens is, the higher the possibility is that the distance between the subject and the imaging lens is long. Comparing a case where the distance between the subject and the imaging lens is long with a case where the distance is short, when the light image shift amounts are the same, the influence of the light image shift on the image is larger in the former case. This is because the longer the distance is, the more the amounts of rotation and movement of the camera due to the light image shift which amounts appear on the screen are amplified.

That is, it can be predicted that the longer the focal length of the imaging lens is, the higher the possibility of the occurrence of a light image shift is. Therefore, the program of the AF controller 265 is changed so that the occurrence of a light image shift is predicted when the focal length of the imaging lens is not less than a predetermined value (for example, a few millimeters). The information on the focal length is calculated by the AF controller 265 obtaining the zooming magnification of the optical system 30 set by the user from the zoom motor driving circuit 2 15.

The contrast calculator 263 captures image data from the A/D converter 205 at predetermined time intervals according to the brightness and the like in the photographing screen for the automatic focusing calculation for the AF controller 265 to determine the degree of focus of the image data, and transfers the result of the calculation to the AF controller 265. When the time interval at which the image data is captured (photographing interval for the AF calculation) is long, the possibility is high that the contents of the formed image are largely changed due to a light image shift before the next data capture.

That is, it can be predicted that the longer the photographing interval for the AF calculation for determining the degree of focus is, the higher the possibility of the occurrence of a light image shift is. Therefore, the program of the AF controller 265 is changed so that the occurrence of a light image shift is predicted when the photographing interval for the AF calculation is not less than a predetermined value (for example, a fraction of a second before the next frame is captured). The information on the photographing interval for the AF calculation is obtained by the AF controller 265 from the contrast calculator 263.

In summary, the AF controller 265 is the light image shift occurrence determining means for predicting the occurrence of a light image shift based on the focal length of the imaging lens and the information on the photographing interval for the AF calculation. It is also the automatic focusing control means for changing the size of the AF block when the occurrence of a light image shift.

Moreover, since the contrast is calculated in the AF block and the result of the calculation is supplied to the AF controller 265 so as to be conducive to the determination of the degree of focus, it can be said that the contrast calculator 263 also constitutes the automatic focusing control means.

Consequently, for example, even if a light image shift occurs during photographing of a subject, the subject to be brought into focus does not readily fall outside the AF block, so that automatic focusing of the subject desired by the user can be performed.

Moreover, since the AF controller 265 as the light image shift occurrence determining means predicts the occurrence of a light image shift based on the focal length of the imaging lens and the information on the photographing interval for the AF calculation, the occurrence of a light image shift can be inexpensively predicted without the provision of a light image shift detector such as a gyro.

Moreover, when the focal length is not less than the predetermined value and when the photographing interval for the AF calculation is not less than the predetermined value, the AF controller 265 predicts the occurrence of a light image shift. Consequently, by appropriately setting these predetermined values, the occurrence of a light image shift can be predicted easily.

FIG. 5 is a flowchart collectively showing the flow of the above-described processing. First, the AF controller 265 captures the information on the lens focal length from the zoom motor driving circuit 215 (step ST1a). Then, the AF controller 265 captures the information on the photographing interval for the AF calculation from the contrast calculator 263 (step ST2a).

Then, the AF calculator 265 determines whether the lens focal length is not less than a predetermined value or not and whether the photographing interval for the AF calculation is not less than a predetermined value or not (step ST3a). When these values are both not less than the predetermined values, the AF calculator 265 determines that there is a possibility of the occurrence of a light image shift, and adopts the AF block of the size for light image shift prevention as shown in FIG. 1 (step ST5a). Otherwise, the AF calculator 265 determines that there is no possibility of the occurrence of a light image shift, and adopts the AF block of the standard size as shown in FIGS. 13 and 14 (step ST4a). Then, the process returns to the main flow.

For the prediction of the occurrence of a light image shift, both the focal length of the imaging lens and the information on the photographing interval for the AF calculation may be used or either of them may be used.

With respect to the size of the AF block, it is necessary only that the size after the change be larger than that before the change. With this, the subject does not readily fall outside the AF block.

<Second Embodiment>

The present invention is a modification of the first embodiment. That is, the present embodiment is an automatic focusing device in which instead of the AF controller 265 predicting the occurrence of a light image shift like in the first embodiment, a light image shift detector such as a gyro or an acceleration sensor is adopted and the determination of the occurrence of a light image shift is performed by the light image shift detector. Moreover, in the present embodiment, when the light image shift amount is not less than a given amount, a warning that the light image shift amount is too large is output to the user.

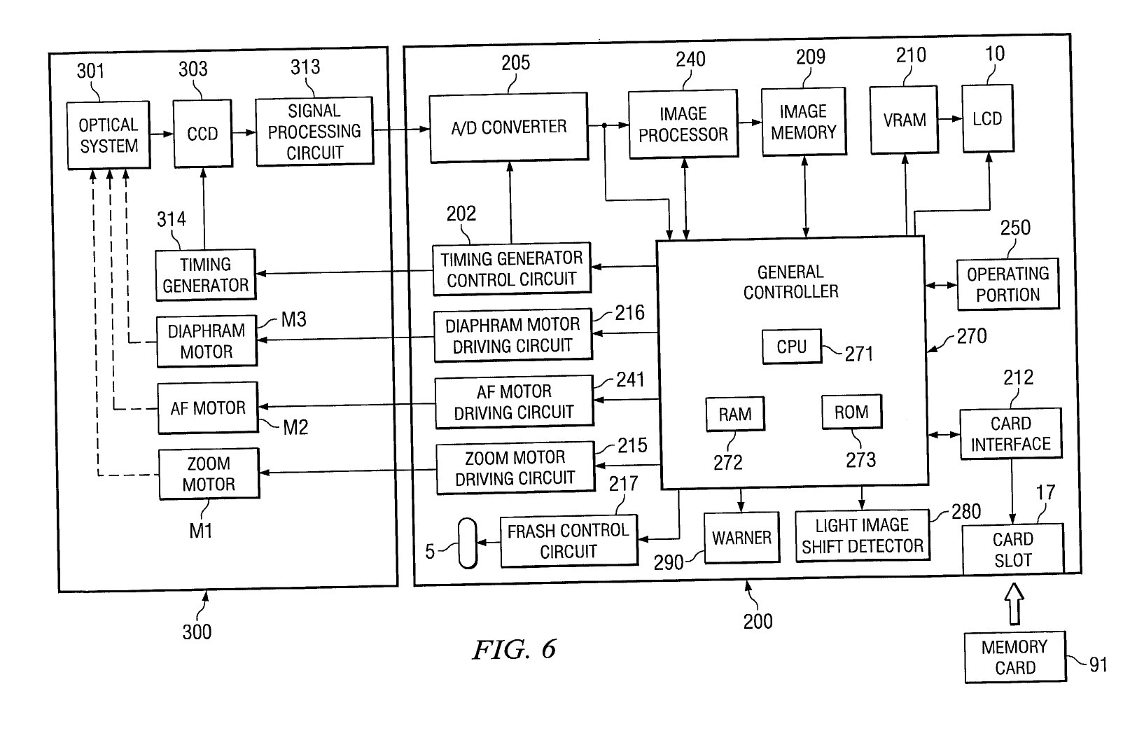

FIG. 6 is a block diagram showing the structure of a digital camera including the automatic focusing device according to the present embodiment. As shown in FIG. 6, this digital camera has a light image shift detector 280 and a warner 290 in addition to the structure of the digital camera of FIG. 3.

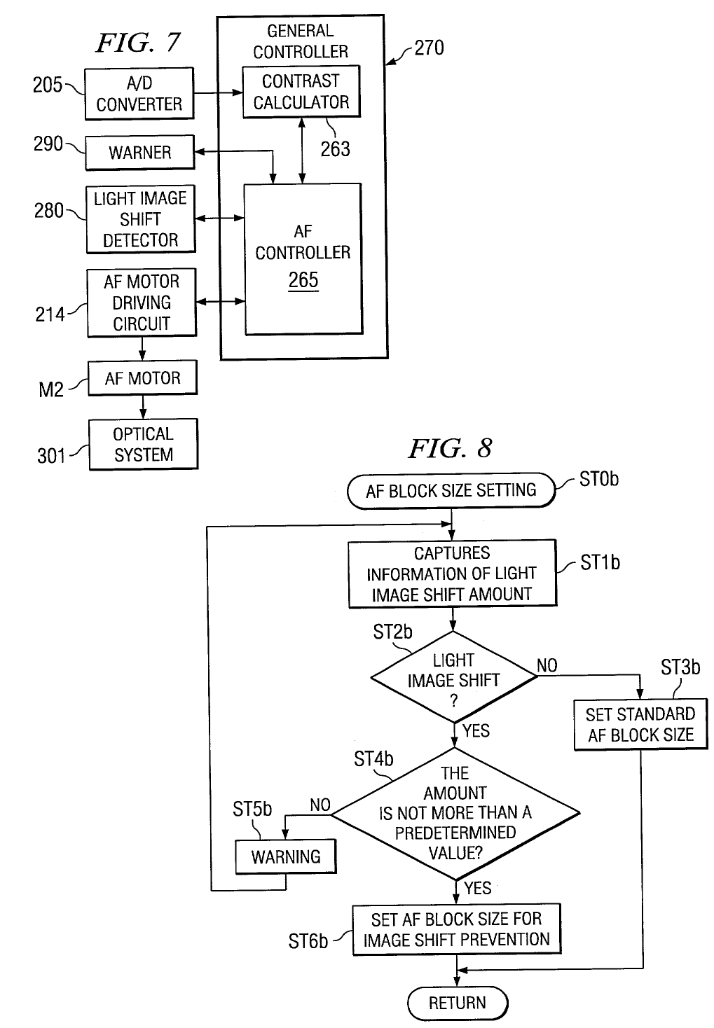

FIG. 7 is, like FIG. 4, a block diagram showing functions of the general controller 270 of the present embodiment. The structure of FIG. 7 is different from that of FIG. 4 in that the AF controller 265 exchanges signals with the light image shift detector 280 and the warner 290.

The light image shift detector 280 is a light image shift detector that detects a light image shift by detecting the value of a velocity element (such as the translational velocity or the angular velocity) or the value of an acceleration element (the translational acceleration or the angular acceleration) applied to the digital camera, and concrete examples thereof include a gyro and an acceleration sensor mentioned above. The light image shift detector 280 is the light image shift occurrence determining means in the present embodiment.

The detection of a light image shift is performed, for example, by the light image shift detector 280 outputting a signal indicating that “a light image shift is present” to the AF controller 265 when a velocity element or an acceleration element of not less than a predetermined value is applied to the light image shift detector 280. Moreover, from the light image shift detector 280, the information on the applied velocity or acceleration is also transmitted to the AF controller 265 as information on the light image shift.

The warner 290 is, for example, a sound generator that generates a warning sound such as a beep, or an image processor that provides a warning display on the LCD 10 so that it is superimposed on the image. The AF controller 265 determines whether the light image shift amount is larger than a predetermined value or not based on the information on the light image shift amount transmitted from the light image shift detector 280. When the amount is larger than the predetermined value, the warner 290 is controlled so as to output a warning that the light image shift amount is too large. Receiving the control signal, the warner 290 generates a warning sound or provides a warning display as described above.

As described above, by the light image shift detector 280 being a light image shift detector that detects a light image shift by detecting a velocity element or an acceleration element, the occurrence of a light image shift can be detected with reliability.

Moreover, by the warner 290 outputting a warning that the light image shift amount is too large when the light image shift amount is larger than a predetermined value, it is possible to urge the user to suppress the light image shift.

The structure other than this will not be described because it is similar to that of the automatic focusing device according to the first embodiment.

FIG. 8 is a flowchart collectively showing the flow of the processing in the present embodiment. First, the AF controller 265 captures the information on the light image shift amount from the light image shift detector 280 (step ST1b).

Then, the AF controller 265 determines whether the light image shift amount is not less than a predetermined value or not (step ST2b). When the value is not less than the predetermined value, the AF controller 265 determines that a light image shift is present. Then, the AF controller 265 determines whether the light image shift amount is not more than a given value (is larger than the predetermined value) or not (step ST4b). When the amount is more than the given value, the warner 290 is instructed to generate a warning sound or provide a warning display (step ST5b). Then, the process returns to step ST1b, where the AF controller 265 captures the information on the light image shift amount from the light image shift detector 280.

When the light image shift amount is not more than the given value, the AF block of the size for light image shift prevention as shown in FIG. 1 is adopted (step ST6b). When it is determined at step ST2b that no light image shift is present, the AF block of the standard size as shown in FIGS. 13 and 14 is adopted (step ST3b).

The warner 290 may be adopted in the automatic focusing device according to the first embodiment. In that case, it is necessary for the AF controller 265 to obtain the information on the light image shift amount from a function block other than the light image shift detector 280; for example, the contrast calculator 263 analyzes the image data captured for the contrast calculation to obtain the information on the light image shift amount.

That is, the contrast calculator 263 recognizes an image data change, for example, by comparing certain image data with the image data of the next frame, and produces a movement vector by performing pattern matching between the images, thereby detecting the velocity and the acceleration.

By doing this, it can be performed to produce the information on the light image shift amount and provide a warning that the light image shift is too large also in the automatic focusing device according to the first embodiment not having the light image shift detector 280.

<Third Embodiment>

The present embodiment is a modification of the second embodiment. That is, the present embodiment is an automatic focusing device in which the light image shift detector 280 detects the light image shift direction as well as the light image shift amount and the size and the placement of the AF block are changed according to the light image shift amount and the light image shift direction. In the present embodiment, when the light image shift amount is not less than a given amount, the position of the AF block is corrected as well while a warning that the light image shift amount is too large is output to the user.

The structure of the digital camera including the automatic focusing device according to the present embodiment will not be described because it is similar to that of the second embodiment.

Next, the operation of the automatic focusing device according to the present embodiment will be described. In the present embodiment, the light image shift detector 280 detects the light image shift direction as well as the light image shift amount.

Light image shift detectors such as gyros and acceleration sensors inherently obtain not only the information on the magnitude of the velocity or the acceleration but also the information on the direction thereof. In the present embodiment, the light image shift detector 280 further outputs to the AF controller 265 the information on the direction of the velocity or the acceleration as the information on the light image shift direction.

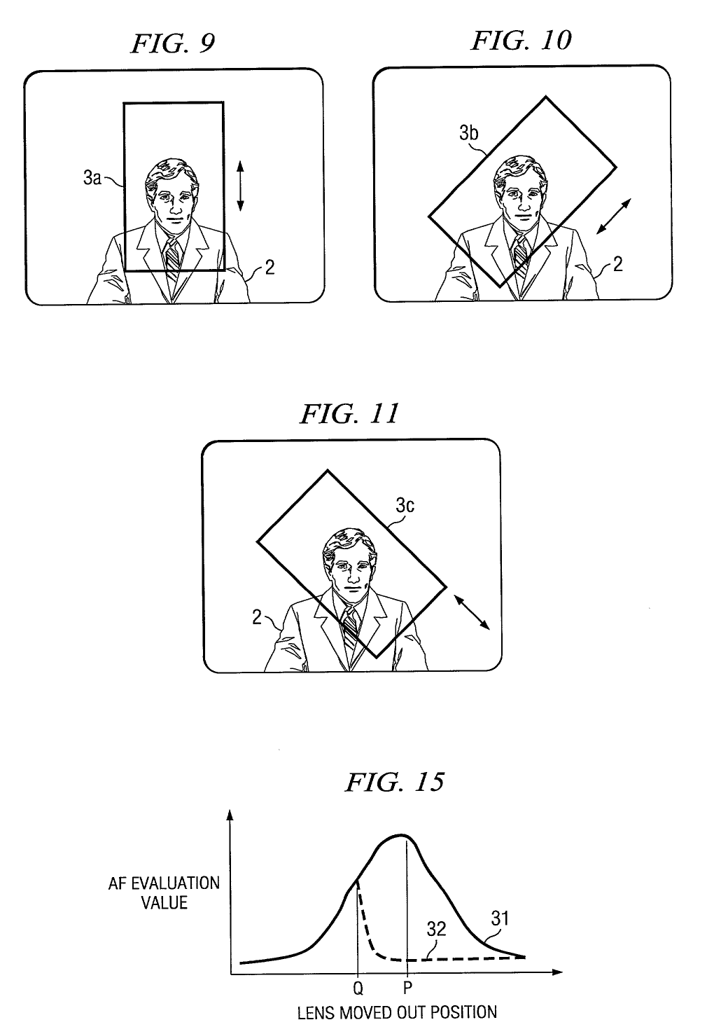

In the AF controller 265, for example, a plurality of kinds of placements of the AF block for light image shift prevention are previously stored in the ROM 273 or the RAM 272. That is, for example, as shown as AF blocks 3a to 3c in FIGS. 9 to 11, the placement of the AF block is changed, according to the light image shift direction, to one selected from among the placements of the AF block stored in the ROM 273 or the RAM 272. In the present embodiment, the AF block is placed so as to extend in the same direction as the light image shift direction. By doing this, the placement of the AF block can be changed to more appropriate one according to the condition of the light image shift, and image information of directions different from the shift direction is never used for automatic focusing, so that automatic focusing can be performed more precisely.

FIG. 9 shows as an example a case where the light image shift direction is perpendicular to the image plane (the arrow shows the light image shift direction). In this case, the perpendicularly extending AF block 3a is selected. FIG. 10 shows as an example a case where the light image shift direction is parallel to a direction extending from the upper right to the lower left of the image plane. In this case, the AF block 3b extending in the same direction as the light image shift direction is selected. FIG. 11 shows a case where the light image shift direction is parallel to a direction extending from the upper left to the lower right of the image plane conversely to the case of FIG. 10. In this case, the AF block 3c extending in the same direction as the light image shift direction is selected.

While in the above description, cases are shown where one placement is selected from among the placements of the AF block previously stored in the ROM 273 or the RAM 272, for example, the AF controller 265 may generates a placement of the AF block in real time according to the detected light image shift direction.

Moreover, the size of the AF block may be changed according to the light image shift amount. For example, in FIG. 1, the larger the light image shift amount is, the more readily the subject 2 falls outside the AF block 3. In this case, the size of the AF block 3 is changed so that the larger the light image shift amount is, the larger (vertically or horizontally longer) than the size before the change the size of the AF block 3 is. By doing this, the size of the AF block can be changed to more appropriate one according to the condition of the light image shift.

The configuration change of the AF block according to the light image shift amount and the light image shift direction as described above can be easily performed only by changing the program of the general controller 270.

The changes of the size and the placement of the AF block according to the light image shift amount and the light image shift direction as described above may be adopted in the automatic focusing device according to the first embodiment as well as in the automatic focusing device according to the second embodiment.

In that case, as described in the last part of the description of the second embodiment, the contrast calculator 263 produces a movement vector, and the light image shift direction is detected based on the movement vector. Then, the information on the light image shift direction is also supplied from the contrast calculator 263 to the AF controller 265, and the AF controller 265 changes the size and the placement of the AF block according to the light image shift amount and the light image shift direction as described above.

Moreover, in the present embodiment, when the light image shift amount is not less than the given amount, the position of the AF block is corrected as well while a warning that the light image shift amount is too large is output to the user.

When the information on the light image shift amount and the light image shift direction is obtained from the light image shift detector 280 or the contrast calculator 263, the AF controller 265 can correct the position of the AF block by using the information on the light image shift amount and the light image shift direction. That is, by moving the position of the AF block by an amount the same as the light image shift amount in a direction opposite to the light image shift direction based on the amount and the direction of the light image shift, the same subject can be made to remain in the AF block. That is, the subject can be more easily prevented from falling outside the AF block.

The correction of the position of the AF block according to the light image shift amount and the light image shift direction as described above can be easily performed only by changing the program of the general controller 270.

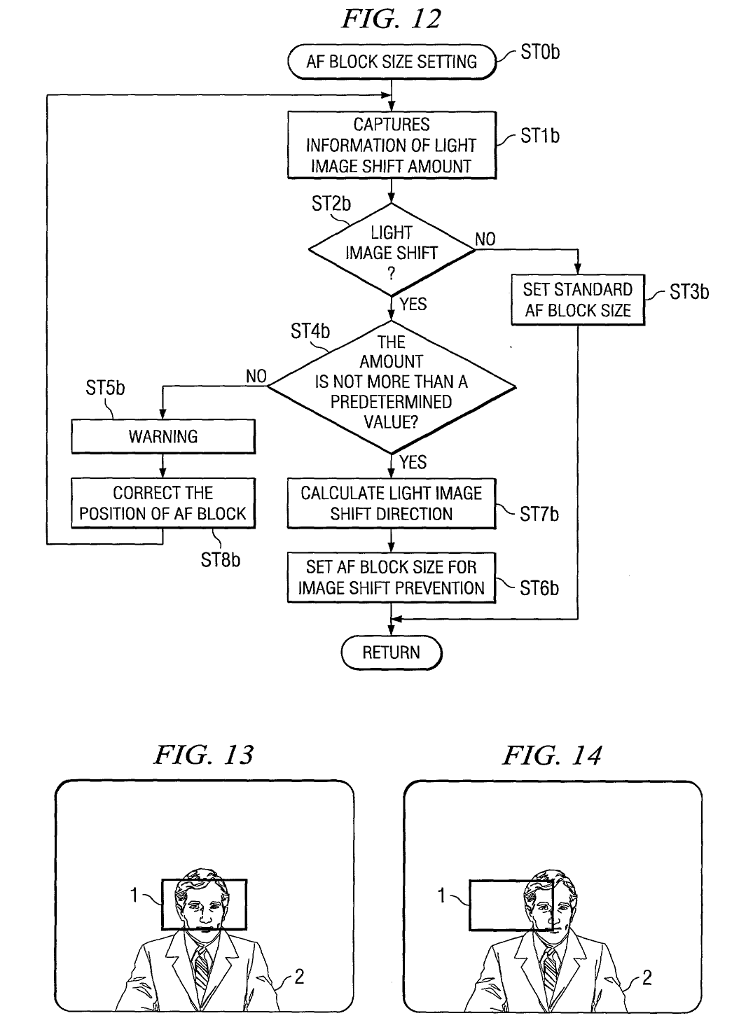

FIG. 12 is a flowchart collectively showing the flow of the processing in the present embodiment. The flow from step ST1b to step ST4b is the same as that in the case of FIG. 8.

In the present embodiment, when the light image shift amount is larger than a given value at step ST4b, the warner 290 is instructed to generate a warning sound or provide a warning display (step ST5b) and the position of the AF block is corrected (step ST8b). Then, the process returns to step ST1b, where the AF controller 265 captures the information on the light image shift amount from the light image shift detector 280.

When the light image shift amount is not more than the given value, the light image shift detector 280 or the contrast calculator 263 calculates the light image shift direction (step ST7b), and based on the information thereon and the information on the light image shift amount, the AF controller 265 adopts an AF block of a size and a placement suitable for the condition of the light image shift as shown in FIGS. 9 to 11 (step ST6b).

As described above, according to the present invention, the automatic focusing control means changes the size of the automatic focusing block when the light image shift occurrence determining means predicts or detects the occurrence of a light image shift. Consequently, even if a light image shift occurs during photographing of a subject, by changing the size of the automatic focusing block, the subject to be brought into focus does not readily fall outside the automatic focusing block, so that automatic focusing of the subject desired by the user can be performed.

Further, the light image shift occurrence determining means predicts the occurrence of a light image shift based on the information on the focal length of the imaging lens and/or the information on a predetermined time interval. Consequently, the occurrence of a light image shift can be inexpensively predicted without the provision of a light image shift detector such as a gyro.

Further, the light image shift occurrence determining means predicts the occurrence of a light image shift when the focal length is not less than a first predetermined value and/or predicts the occurrence of a light image shift when the predetermined time interval is not less than a second predetermined value. Consequently, by appropriately setting the first and the second predetermined values, the occurrence of a light image shift can be easily predicted.

Further, the light image shift occurrence determining means is a light image shift detector that detects a light image shift by detecting a velocity element value or an acceleration element value. Consequently, the light image shift occurrence determining means can detect the occurrence of a light image shift with reliability.

Further, the size of the automatic focusing block after the change is larger than that before the change. Consequently, the subject does not readily fall outside the automatic focusing block.

Further, the light image shift occurrence determining means detects, or identifies by a prediction based on an image data change, the light image shift amount and/or the light image shift direction, and the automatic focusing control means changes the size of the automatic focusing block according to the light image shift amount and/or the light image shift direction. Consequently, the size of the automatic focusing block can be changed to more appropriate one according to the condition of the light image shift.

Further, the automatic focusing control means performs at least one of (a) a first processing to change the size of the automatic focusing block so that the larger the light image shift amount is, the larger than the size before the change the size of the automatic focusing block is and a second processing to place the automatic focusing block so as to extend in the same direction as the light image shift direction. Consequently, the size and/or the placement of the automatic focusing block can be changed to more appropriate one according to the light image shift amount and/or the light image shift direction.

Further, warning means is provided for outputting a warning that the light image shift amount is too large when the light image shift amount is larger than a third predetermined value. Consequently, it is possible to urge the user to suppress the light image shift.

Further, the automatic focusing control means corrects the position of the automatic focusing block based on the information on the light image shift amount and/or the light image shift direction. Consequently, the subject does not readily fall outside the automatic focusing block.

Although the present invention has been fully described in connection with the preferred embodiments thereof with reference to the accompanying drawings, it is to be noted that various changes and modifications are apparent to those skilled in the art. Such changes and modifications are to be understood as included with in the scope of the present invention as defined by the appended claims unless they depart therefrom.

What is claimed is:

1. An automatic focusing device, comprising:
an automatic focusing controller for calculating an optical physical quantity within an automatic focusing block as which an area in image data is specified, and determining the degree of focus of the image data; and
a light image shift occurrence determiner for predicting or detecting the occurrence of a light image shift,
wherein the automatic focusing controller changes the size of the automatic focusing block when the light image shift occurrence determiner predicts or detects the occurrence of a light image shift.

2. The automatic focusing device according to claim 1, wherein the automatic focusing controller captures the image data at predetermined time intervals and determines the degree of focus of the image data, and the light image shift occurrence determiner predicts the occurrence of a light image shift based on information on the focal length of an imaging lens and/or information on the predetermined time interval.

3. The automatic focusing device according to claim 2, wherein
the light image shift occurrence determiner predicts the occurrence of a light image shift when the focal length is not less than a first predetermined value and/or predicts the occurrence of a light image shift when the predetermined time interval is not less than a second predetermined value.

4. The automatic focusing device according to claim 1, wherein the light image shift occurrence determiner detects a light image shift by detecting the value of a velocity element or an acceleration element of an apparatus performing focus control with the automatic focusing device.

5. The automatic focusing device according to claim 1, wherein the size of the automatic focusing block after the change is larger than that before the change.

6. The automatic focusing device according to claim 1, wherein the light image shift occurrence determiner detects, or identifies by a prediction based on the image data change, the light image shift amount and/or the light image shift direction, and the automatic focusing controller changes the size of the automatic focusing block according to the light image shift amount and/or the light image shift direction.

7. The automatic focusing device according to claim 6, wherein the automatic focusing controller performs at least one of a first processing to change the size of the automatic focusing block so that the larger the light image shift amount is, the larger than the size before the change the size of the automatic focusing block is and a second processing to place the automatic focusing block so as to extend in the same direction as the light image shift direction.

8. The automatic focusing device according to claim 6, further comprising:
a warning portion for outputting a warning signal that the light image shift amount is too large when the light image shift amount is larger than a third predetermined value.

9. The automatic focusing device according to claim 6, wherein the automatic focusing controller corrects the position of the automatic focusing block based on the information of the light image shift amount and/or the light image shift direction.

10. An automatic focusing device, comprising:
an automatic focusing portion for performing focusing of image data by using image information in the image data;
a light image shift detecting portion for detecting information of a light image shift; and
a changing portion for changing a method for obtaining the image information by the automatic focusing portion, based on an output from the light image shift detecting portion.

11. The automatic focusing device according to claim 10, wherein the automatic focusing portion calculates an optical physical quantity within an automatic focusing block as which an area in the image data is specified, and determines the degree of focus of the image data.

12. The automatic focusing device according to claim 11, wherein the change of the obtaining method by the changing portion is made by changing the size of the automatic focusing block.

13. The automatic focusing device according to claim 12, wherein the changing portion changes the size of the automatic focusing block so that it is larger than that before the change, when the light image shift detecting portion detects the occurrence of a light image shift.

14. An automatic focusing device, comprising:
an automatic focusing portion for performing focusing of image data by using image information in the image data; and
light image shift occurrence determining portion for predicting or detecting the occurrence of a light image shift,
wherein the automatic focusing portion is provided with changing portion for changing a method for obtaining the image information by the automatic focusing portion, when the light image shift occurrence determining portion predicts or detects the occurrence of a light image shift.

15. The automatic focusing device according to claim 14, wherein the automatic focusing portion calculates an optical physical quantity within an automatic focusing block as which an area in the image data is specified, and determines the degree of focus of the image data.

16. The automatic focusing device according to claim 15, wherein the change of the obtaining method by the changing portion is made by changing the size of the automatic focusing block.

17. The automatic focusing device according to claim 16, wherein the changing portion changes the size of the automatic focusing block so that it is larger than that before the change, when the light image shift detecting portion detects the occurrence of a light image shift.

18. The automatic focusing device according to claim 14, wherein the light image shift occurrence determining portion detects, or identifies by a prediction based on the image data change, the light image shift amount and/or the light image shift direction, and the automatic focusing portion changes the size of the automatic focusing block according to the light image shift amount and/or the light image shift direction.
